(19) United States
(12) Patent Application Publication
(10) Pub. No.: US 2026/0213111 A1
(43) Pub. Date: Jul. 23, 2026

(54) CATHODE AND MANUFACTURING METHOD THEREOF

(71) Applicant: Shanghai United Imaging Healthcare Co., Ltd., Shanghai (CN)

(72) Inventors: Zhuang Zhang, Shanghai (CN); Gang Pan, Shanghai (CN)

(21) Appl. No.: 19/434,047

(22) Filed: Dec. 29, 2025

(30) Foreign Application Priority Data
Dec. 28, 2024 (CN) 202411965375.1

(51) Int. Cl. H01J 9/04; H01J 1/14

(52) U.S. Cl. CPC H01J 9/047; H01J 1/14; H01J 2209/012

(57) ABSTRACT

The present application relates to a cathode and a manufacturing method thereof. The method includes: mixing and reacting cations containing a cathode element with a precipitant in a solution to obtain a gelatinous precipitate; and coating the gelatinous precipitate on a surface of a cathode substrate, which is configured for forming the cathode.

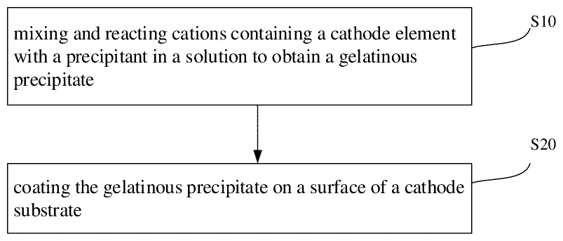

### CROSS-REFERENCE TO RELATED APPLICATION

This application claims priority to Chinese patent application No. 2024119653751, filed on Dec. 28, 2024, the content of which is hereby incorporated by reference in its entirety.

### TECHNICAL FIELD

The present application relates to the technical field of vacuum electron devices, and in particular, to a cathode and a manufacturing method thereof.

### BACKGROUND

Currently, impregnated cathodes are widely used as electron sources in high-power microwave vacuum electron devices. The impregnated cathode refers to a cathode manufactured by melting a cathode active material at high temperature and impregnating it into porous tungsten via capillary action. The manufacture of an impregnated cathode involves two crucial steps: one is the preparation of the cathode active material, and the other is the high-temperature melting impregnation process.

The cathode active material can be prepared by two methods: the solid-phase method and the liquid-phase method. The solid-phase method involves weighing BaCO₃, CaCO₃, and Al₂O₃ in proportion, mixing and then calcining them at high temperature to yield barium-calcium aluminate (abbreviated as aluminate). The liquid-phase method involves weighing soluble nitrates of Ba, Ca, and Al in proportion and preparing them into a nitrate solution of a certain concentration; the nitrate solution is mixed with a precipitant such as ammonium carbonate or ammonium bicarbonate and subjected to a co-precipitation reaction; the precipitate is filtered, washed, and dried to obtain a precursor; and the precursor is subsequently calcined at high temperatures to yield barium-calcium aluminate. The resulting barium-calcium aluminate serves as the cathode active material.

In conventional techniques, manufacturing small-sized cathodes primarily involves covering the entire cathode with active material powder, followed by high-temperature melting to achieve complete cathode impregnation. However, this impregnation method leaves a large amount of residual active material (also referred to as residual salt) on the cathode surface, increasing the difficulty of residual salt removal, which requires additional mechanical grinding, polishing, or machining, not only adding process steps but also increasing the possibility of moisture absorption and contamination of the cathode, finally resulting in low impregnation efficiency. For large-sized or irregularly shaped cathodes, a more common method involves mixing active material powder with a nitrocellulose solution, such as a nitrating cotton solution, or other organic binders such as polyvinyl butyral (PVB) solution, and applying the mixture to the cathode surface, followed by high-temperature melting to achieve complete cathode impregnation. However, nitrocellulose is flammable and explosive, and has adverse effects on both operators and the environment, so its use should be reduced or avoided. Although an organic binder has a much less impact on operators and the environment, its incomplete decomposition at high temperature can leave small amounts of organic carbon residue in the pores of the tungsten substrate. Impregnated cathodes operating in high-vacuum environments (<10⁻⁶ Pa) require extremely high internal purity. In such a high-vacuum environment, where very few gas molecules are present, any foreign impurity gases, including the gases produced by decomposition of residual organic carbon at high temperature, can disrupt this high-vacuum state, causing arcing, reducing device lifespan, and even leading to malfunction of the device. Thus, the conventional techniques still require further improvement.

### SUMMARY

In view of this, the present application provides a simple method for manufacturing a thermionic cathode with relatively few impurities, and accordingly provides a cathode and a manufacturing method thereof.

The specific technical solutions are as follows:

A first aspect of the present application provides a method for manufacturing a cathode, including:
mixing and reacting cations containing a cathode element with a precipitant in a solution to obtain a gelatinous precipitate; and
coating the gelatinous precipitate on a surface of a cathode substrate.

According to the method for manufacturing the thermionic cathode in the present application, cations containing a cathode element are mixed and reacted with a precipitant in a solution to obtain a gelatinous precipitate, and the gelatinous precipitate is coated on the surface of a cathode substrate, which is configured for forming the cathode. The gelatinous precipitate behaves like a “glue”, exhibiting strong adhesion when not fully dried, firmly binding other precipitate particles together. Moreover, because the mixing process is at the molecular level, this binding is tighter and more uniform. When coated on the surface of the cathode substrate, the gelatinous precipitate enables firm adhesion of the active material to the cathode substrate.

Compared with conventional processes, the present method simplifies the process by eliminating the high-temperature calcination step for forming the aluminate active material. This manufacturing method utilizes coprecipitation reaction and characteristics of the gelatinous precipitate, and thus is expected to achieve more uniform mixing of the active material, improve the contact performance between the material and the electrode substrate, reduce the detachment of the active material under high-vacuum and high-temperature conditions, and reduce impurities. Thus, the present method can avoid the issues associated with the use of binders, such as impaired electrical conductivity or residual impurities, thereby extending the service life of the electronic devices.

In some embodiments, the method further includes:
drying the cathode substrate coated with the gelatinous precipitate to obtain a dried cathode substrate; and
subjecting the dried cathode substrate to melting impregnation.

In some embodiments, mixing and reacting the cations containing the cathode element with the precipitant in the solution to obtain the gelatinous precipitate includes:
in a pH value ranging from 8 to 10, mixing and reacting the cations containing the cathode element with the precipitant in the solution to obtain the gelatinous precipitate

In some embodiments, the gelatinous precipitate includes a hydroxide of the cathode element, an oxyhydroxide of the cathode element, or a combination thereof.

In some embodiments, during mixing and reacting the cations containing the cathode element with the precipitant in the solution, a reaction temperature is in a range from 20° C. to 80° C., and/or a reaction time lasts for 0.5 hours to 2 hours.

In some embodiments, the precipitant includes a carbonate, and/or the solution contains nitrate ions.

In some embodiments, a molar ratio of the cations to the precipitant is in a range from 1:2 to 1:5.

In some embodiments, the cathode element includes aluminum, scandium, yttrium, or any combination thereof.

In some embodiments, during the method for manufacturing the cathode, no binder is coated on the cathode substrate.

A second aspect of the present application provides a cathode applied in a microwave device, the cathode being manufactured by the above-described method.

### BRIEF DESCRIPTION OF THE DRAWING

The sole FIGURE is a flow chart of an embodiment of a method for manufacturing a cathode provided by the present application.

### DETAILED DESCRIPTION

For easy understanding of the present application, the present application will be comprehensively described below with reference to some embodiments of the present application. However, the present application can be implemented in many different forms and is not limited to the embodiments described herein. Rather, these embodiments are provided to more thoroughly and comprehensively disclose the present application.

The implementation of the present application is described in detail below with reference to some embodiments and examples. These embodiments are implemented on the premise of the technical solutions of the present application, providing detailed implementation methods and specific operational procedures. However, the protection scope of the present application is not limited to the following embodiments.

Unless otherwise defined, all technical and scientific terms used herein have the same meaning as commonly understood by those of ordinary skill in the art to which the present application pertains. The terms used in the specification of the present application herein are for the purpose of describing specific embodiments only and are not intended to limit the present application.

Unless otherwise stated or there is a contradiction, the terms or phrases used herein have the following meanings.

In the present application, the terms “a plurality of”, “multiple”, and the like refer to a number equal to or greater than 2, unless otherwise specified. For example, “one or more” means one, two or more.

In the present application, “further”, “specially”, etc., are for descriptive purposes, indicating the differences in content, but cannot be understood as a limitation on the protection scope of the present application.

In the present application, an open-ended description for the technical features encompasses not only a closed-ended technical solution consisting of the listed features, but also an open-ended technical solution including the listed features.

In the present application, when a numerical interval (i.e., a numerical range) is mentioned, unless otherwise specified, the suitable values are considered as being continuously distributed within the numerical interval, and includes two numerical endpoints (i.e., the minimum and maximum values) as well as every value between the two numerical endpoints. Unless otherwise specified, when the numerical interval refers to only integers in the numerical interval, the two end integers of the numerical interval and every integer between the two end integers are included, being equivalent to directly enumerating each integer. When multiple numerical ranges are provided to describe a feature or characteristic, these numerical ranges can be combined. In other words, unless otherwise indicated, the numerical ranges disclosed in the present application should be understood to encompass any and all subranges included therein. The “values” in the numerical interval can be any quantitative values, such as numbers, percentage, and ratios. The term “numerical interval” broadly encompasses types of numerical intervals, such as percentage intervals, proportion intervals, and ratio intervals.

In the present application, when a temperature parameter is mentioned, unless otherwise specifically stated, not only a thermostatic process but also a variation within a certain temperature interval is allowed. It should be understood that the thermostatic process allows for temperature fluctuations within the accuracy range of the instrument, such as fluctuation within the range of ±5° C., ±4° C., ±3° C., ±2° C. and ±1° C.

In the present application, for unit of a numerical range, if the unit only appears after the right endpoint, it means that the units of both the left endpoint and the right endpoint are the same. For example, “2 to 5 h” denotes that the unit hours (h) applying to both the left endpoint “2” and the right endpoint “5”.

A cathode is composed of a cathode active material and a cathode substrate. A thermionic cathode is a special cathode structure, consisting of a cathode active material and a cathode substrate. These two components play different but mutually synergistic functions in the thermionic emission process. The cathode active material is a crucial component responsible for thermionic emission and has a low work function. A heated cathode active material enables electrons to gain sufficient energy to overcome the surface potential barrier and be emitted. The cathode substrate primarily serves to provide mechanical support and thermal conduction. In the thermionic emission process, the cathode substrate first receives and transfers heat, thereby activating the electrons in the cathode active material. These activated electrons are influenced by factors such as electric fields at the interface between the active material and the substrate, as well as on the surface of the active material itself, overcoming the constraint of the surface work function and being emitted into vacuum in application scenarios such as vacuum electron devices.

Referring to the sole FIGURE, an embodiment of the present application provides a method for manufacturing a cathode, including steps S10 and S20.

Step S10: Mixing and reacting cations containing a cathode element with a precipitant in a solution to obtain a gelatinous precipitate.

Specifically, mixing and reacting the cations containing the cathode element with the precipitant in the solution to obtain the gelatinous precipitate includes: in a pH value ranging from 8 to 10, mixing and reacting the cations containing the cathode element with the precipitant in the solution to obtain the gelatinous precipitate. For example, the pH value can be, but is not limited to, 8, 8.5, 9, 9.5, or 10. In some examples, the pH value can be in a range defined by any two of these point values as endpoints. Exemplarily, the cathode element can include aluminum (Al), scandium (Sc), yttrium (Y), etc. Exemplarily, the cations can include aluminum ions (e.g., Al³⁺), scandium ions (e.g., Sc³⁺), yttrium ions (e.g., Y³⁺), etc. Exemplarily, the precipitant can include ammonium carbonate ((NH₄)₂CO₃), ammonium bicarbonate (NH₄HCO₃), etc.

In some embodiments, the gelatinous precipitate includes a hydroxide of the cathode element, an oxyhydroxide of the cathode element, or a combination thereof.

In some embodiments, the gelatinous precipitate includes Al(OH)₃, AlOOH, or a combination thereof.

As a specific example, it can be understood that in an alkaline solution, aluminum ions can undergo hydrolysis reactions: Al³⁺+3H₂O═Al(OH)₃↓+3H⁺, yielding Al(OH)₃. By controlling a specific pH value, AlOOH can also be yielded: Al³⁺+OH⁻+H₂O→AlOOH+H⁺. Both Al(OH)₃ and AlOOH are gelatinous precipitates with strong adhesion when not fully dried. This characteristic allows them to more effectively achieve “molecular-level” uniform mixing with other active material precipitates.

Furthermore, mixing and reacting the cations with the precipitant in the solution includes the following step: adding a solution containing the cations dropwise into a solution containing the precipitant at a rate of 100 mL/min to 600 mL/min. For example, the dropwise addition rate can be 100 mL/min, 110 mL/min, 120 mL/min, 130 mL/min, 140 mL/min, 150 mL/min, 160 mL/min, 170 mL/min, 180 mL/min, 190 mL/min, 200 mL/min, 210 mL/min, 220 mL/min, 230 mL/min, 240 mL/min, 250 mL/min, 260 mL/min, 270 mL/min, 280 mL/min, 290 mL/min, 300 mL/min, 310 mL/min, 320 mL/min, 330 mL/min, 340 mL/min, 350 mL/min, 360 mL/min, 370 mL/min, 380 mL/min, 390 mL/min, 400 mL/min, 410 mL/min, 420 mL/min, 430 mL/min, 440 mL/min, 450 mL/min, 460 mL/min, 470 mL/min, 480 mL/min, 490 mL/min, 500 mL/min, 510 mL/min, 520 mL/min, 530 mL/min, 540 mL/min, 550 mL/min, 560 mL/min, 570 mL/min, 580 mL/min, 590 mL/min, or 600 mL/min.

It can be understood that controlling the dropwise addition rate of the cation solution within the above range allows the cation solution to be uniformly dispersed into the precipitant solution, enabling the precipitation reaction to proceed smoothly and orderly, thereby facilitating the formation of precipitates with uniform particle size and good dispersibility. If the dropwise addition rate is too fast, a local concentration of the reactants will instantaneously become over high, leading to a massive and intense precipitation reaction in a short time. This easily results in uneven precipitate particle sizes and may lead to large aggregated particles and difficulty in stably controlling conditions of the reaction system such as the pH value.

In some embodiments, during mixing and reacting the cations with the precipitant in the solution, the reaction temperature is in a range from 20° C. to 80° C., and/or the reaction time lasts for 0.5 hours to 2 hours. For example, the reaction temperature can be 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., or 80° C. The reaction time can last for 0.5 hours, 1 hours, 1.5 hours, or 2 hours.

It can be understood that the above reaction conditions are controlled, as an increase in temperature may accelerate the reaction rate and also affect the crystal form and particle size of the precipitate. A suitable temperature and pH value range can ensure that the resulting gelatinous precipitate has excellent properties, can effectively mix with other precipitate components, and performs well during the subsequent coating process.

In a specific example, during mixing and reacting the cations with the precipitant in the solution, the reaction temperature is 40° C., and/or the reaction time lasts for 1 hour.

In some embodiments, the precipitant includes a carbonate.

In some embodiments, the precipitant includes at least one of ammonium carbonate or ammonium bicarbonate.

In some embodiments, additionally or alternatively, the solution contains nitrate ions.

In some embodiments, in the precipitant solution, the concentration of the precipitant is in a range from 1 mol/L to 3 mol/L.

It can be understood that a suitable concentration of the precipitant is conducive to controlling the reaction rate, the size of the precipitate particles, and the uniformity of precipitate formation. The above concentration range allows the reaction to proceed in a relatively stable and controllable chemical environment, preventing excessively vigorous reaction and formation of large aggregated precipitate particles due to overly high concentration, or excessively slow reaction and low efficiency due to excessively low concentration.

In some embodiments, in the precipitant solution, the concentration of the precipitant is 2 mol/L.

In some embodiments, a molar ratio of the cations to the precipitant is in a range from 1:2 to 1:5, for example, the molar ratio can be 1:1, 1:2, 1:3, 1:4, or 1:5.

In some embodiments, the molar ratio of the cations to the precipitant is 1:4.

In some embodiments, the cathode element includes at least one of aluminum (Al), scandium (Sc), or yttrium (Y).

In some embodiments, the cathode element further includes at least one of barium (Ba) or calcium (Ca).

It can be understood that Ba and Ca are precipitated from the solution in the form of BaCO₃ and CaCO₃, while Al is precipitated in a complex form, possibly yielding (NH)₄Al(OH)₂CO₃, Al(OH)₃, or AlOOH. Among them, Al(OH)₃ and AlOOH are gelatinous precipitates with strong adhesion when not completely dried.

In a specific example, when using ammonium carbonate as the precipitant, the following chemical reaction occurs to yield (NH₄)Al(OH)₂CO₃:

2Al(NO₃)₃+3(NH₄)₂CO₃+2H₂O→2(NH₄)Al(OH)₂CO₃+6NH₄NO₃+2CO₂↑.

In a specific example, when using ammonium bicarbonate as the precipitant, the following chemical reaction occurs to yield (NH₄)Al(OH)₂CO₃:

Al(NO₃)₃+2NH₄HCO₃+2H₂O→(NH₄)Al(OH)₂CO₃+3NH₄NO₃+2CO₂↑.

Step S20: Coating the gelatinous precipitate on a surface of a cathode substrate.

Specifically, after step S20, the method further includes step S30 and step S40.

Step S30: Drying the cathode substrate coated with the gelatinous precipitate to obtain a dried cathode substrate.

In some embodiments, the material of the cathode substrate includes at least one of porous molybdenum, porous tungsten, or a combination thereof.

In some embodiments, the coating step includes spin coating, drop coating, spray coating, or blade coating.

It can be understood that coating the gelatinous precipitate on the surface of the cathode is to adopt the adhesiveness of the gelatinous precipitate. The precipitate uniformly covers the cathode surface after coating to avoid local thickness variations. The above coating method such as spin coating, drop coating, spray coating, or blade coating, can be employed to achieve a good coating effect.

In some embodiments, the drying step is performed at a temperature of 100° C. to 300° C. under vacuum for 2 hours to 5 hours.

It can be understood that the drying step is performed to remove volatile components such as water, thereby initially stabilizing the structure of the coating layer.

In a specific example, the drying step is performed at 200° C. under vacuum for 3 hours.

Step S40: Subjecting the dried cathode substrate to melting impregnation to obtain the cathode.

In some embodiments, the melt impregnation includes in a hydrogen atmosphere, heating to a temperature of 1000° C. to 1200° C. at a rate of 30° C./min to 60° C./min and then holding the temperature for 3 minutes to 8 minutes, and further heating to a temperature of 1550° C. to 1750° C. at a rate of 10° C./min to 30° C./min and then holding the temperature for 1 minute to 5 minutes.

When the dried cathode is placed in a hydrogen atmosphere for melt impregnation, a series of physical and chemical changes may occur under high-temperature conditions, which further improves the bonding between the active material and the cathode substrate and promotes the optimization of the internal structure of the active material, ultimately yielding a high-quality cathode active material.

In a specific example, the melt impregnation includes: in a hydrogen atmosphere, heating to a temperature of 1100° C. at a rate of 50° C./min and then holding the temperature for 5 minutes, and further heating to a temperature of 1650° C. at a rate of 20° C./min and then holding the temperature for 3 minutes.

In some embodiments, during the method for manufacturing the cathode, no binder is coated on the cathode substrate.

According to the method for manufacturing the thermionic cathode in the present application, cations containing a cathode element are mixed and reacted with a precipitant in a solution to obtain a gelatinous precipitate, and the gelatinous precipitate is coated on the surface of a cathode substrate, which is configured for forming the cathode. The gelatinous precipitate behaves like a “glue”, exhibiting strong adhesion when not fully dried, firmly binding other precipitate particles together. Moreover, because the mixing process is at the molecular level, this binding is tighter and more uniform. When coated on the surface of the cathode substrate, the gelatinous precipitate enables firm adhesion of the active material to the cathode substrate.

Compared with conventional processes, the present method simplifies the process by eliminating the high-temperature calcination step for forming the aluminate active material. This manufacturing method utilizes coprecipitation reaction and characteristics of the gelatinous precipitate, and thus is expected to achieve more uniform mixing of the active material, improve the contact performance between the material and the electrode substrate, reduce the detachment of the active material under high-vacuum and high-temperature conditions, and reduce impurities. Thus, the present method can avoid the issues associated with the use of binders, such as impaired electrical conductivity or residual impurities, thereby extending the service life of the electronic devices.

The method for manufacturing the thermionic cathode eliminates the need for a binder during coating and impregnation, simplifying the process flow to achieve large-scale mass production.

An embodiment of the present application provides a cathode applied in a microwave device, and the cathode is manufactured using the aforementioned method.

The cathode exhibits a high emission current density and uniform emission quality. The method for manufacturing the cathode eliminates the high-temperature calcination step for the aluminate active material, has a simplified process and enhanced impregnation efficiency. Issues associated with the use of a binder, such as impaired electrical conductivity or residual impurities can be avoided, thereby improving the cathode performance, such as increasing electron emission efficiency and extending the service life of the cathode.

An embodiment of the present application also provides a thermionic device, which includes the thermionic cathode manufactured by the aforementioned method, the aforementioned thermionic cathode, or a combination thereof.

The thermionic device further includes a focusing electrode, an anode, and a heater. The heater can be a filament configured to heat the cathode. A high positive voltage is applied to the anode, allowing the cathode to obtain sufficient current for emission and accelerating the emitted current. The focusing electrode provides a magnetic focusing force to counteract the space-charge force within the electron beam, balancing the two forces so that electrons travel along the magnetic field lines.

It can be understood that the thermionic cathode excites electron emission through heating. When the cathode material is heated to a sufficiently high temperature, electrons inside the cathode gain enough energy to overcome the surface potential barrier and escape into the vacuum. The electrons emitted by the thermionic cathode form an electron current under the action of the internal electric field of the device. This current is the basis for the operation of thermionic devices and can be used for various functions, such as signal amplification and rectification.

The present application can be used in various microwave vacuum devices, such as klystrons, traveling-wave tubes, gyrotrons, and magnetrons, and can also be used in impregnated diffusion cathodes for space ion thrusters.

To make the objectives, technical solutions, and advantages of the present application clearer and more understandable, the present application is described with reference to the following specific examples. However, the present application is not limited to these examples. The examples described below are only some embodiments of the present application and are intended to illustrate the present application, but should not be construed as limiting the scope of the present application. It should be noted that any modifications, equivalent replacements, and improvements made within the spirit and principles of the present application shall fall within the protection scope of the present application.

To better illustrate the present application, the content of the present application is further explained below with reference to the examples.

### Example 1

(1) Raw materials Ba(NO₃)₂, Ca(NO₃)₂·4H₂O, and Al(NO₃)₃·9H₂O for preparing a composite material were weighed according to a molar ratio of BaO:CaO:Al₂O₃ of 6:1:2, and dissolved in deionized water to prepare a 0.2 mol/L cation solution, which was heated to 40° C.

(2) A precipitant (NH₄)₂CO₃ at an amount equal to 4 times the molar amount of cations in the cation solution obtained in step (1) was weighed, and dissolved in deionized water to prepare a 2 mol/L precipitant solution, which was heated to 40° C.

(3) The cation solution obtained in step (1) was added dropwise into the precipitant solution obtained in step (2) at a rate of 300 mL/min under stirring, and heated to react in a 40° C. water bath, with the system pH value controlled at 10.

(4) After the reaction in step (3) completed, the stirring and heating were stopped, and the system was stood for 24 hours and then filtered to obtain a gelatinous precipitate. The gelatinous precipitate was collected and washed until the pH value reached 7 to obtain a composite material for impregnating the cathode.

(5) The composite material obtained in step (4) was coated onto the surface of a cathode substrate, which was specifically a porous tungsten substrate, and dried at 200° C. under vacuum to obtain a dried cathode.

(6) The dried cathode from step (5) was placed into a hydrogen furnace, heated to 1100° C. at a rate of 50° C./min and then hold at 1100° C. for 5 minutes, and subsequently heated to 1650° C. at a rate of 20° C./min and then hold at 1650° C. for 3 minutes. After that, the heated cathode was cooled to room temperature, and the hydrogen furnace was opened to obtain a resulting thermionic cathode.

### Example 2

(1) Raw materials Ba(NO₃)₂, Ca(NO₃)₂·4H₂O, and Al(NO₃)₃·9H₂O for preparing a composite material were weighed according to a molar ratio of BaO:CaO:Al₂O₃ of 6:1:2, and dissolved in deionized water to prepare a 0.2 mol/L cation solution, which was heated to 40° C.

(2) A precipitant NH₄HCO₃ at an amount equal to 4 times the molar amount of cations in the cation solution obtained in step (1) was weighed, and dissolved in deionized water to prepare a 2 mol/L precipitant solution, which was heated to 40° C.

(3) The cation solution obtained in step (1) was added dropwise into the precipitant solution obtained in step (2) at a rate of 300 mL/min under stirring, and heated to react in a 40° C. water bath, with the system pH value controlled at 10.

(4) After the reaction in step (3) completed, the stirring and heating were stopped, and the system was stood for 24 hours and then filtered to obtain a gelatinous precipitate. The gelatinous precipitate was collected and washed until the pH value reached 7 to obtain a composite material for impregnating the cathode.

(5) The composite material obtained in step (4) was coated onto the surface of a cathode substrate, which was specifically a porous molybdenum substrate, and dried at 200° C. under vacuum to obtain a dried cathode.

(6) The dried cathode from step (5) was placed into a hydrogen furnace, heated to 1100° C. at a rate of 50° C./min and then hold at 1100° C. for 5 minutes, and subsequently heated to 1650° C. at a rate of 20° C./min and then hold at 1650° C. for 3 minutes. After that, the heated cathode was cooled to room temperature, and the hydrogen furnace was opened to obtain a resulting thermionic cathode.

### Example 3

(1) Raw materials Ba(NO₃)₂, Ca(NO₃)₂·4H₂O, Al(NO₃)₃·9H₂O, and H₂N₃O₁₀Sc for preparing a composite material were weighed, where Ba(NO₃)₂, Ca(NO₃)₂·4H₂O, and Al(NO₃)₃·9H₂O were weighed according to a molar ratio of BaO:CaO:Al₂O₃ of 6:1:2, and H₂N₃O₁₀Sc was weighed according to 3 wt % of the total mass of BaO, CaO, and Al₂O₃. The raw materials were dissolved in deionized water to prepare a 0.2 mol/L cation solution, which was heated to 40° C.

(2) A precipitant (NH₄)₂CO₃ at an amount equal to 4 times the molar amount of cations in the cation solution obtained in step (1) was weighed, and dissolved in deionized water to prepare a 2 mol/L precipitant solution, which was heated to 40° C.

(3) The cation solution obtained in step (1) was added dropwise into the precipitant solution obtained in step (2) at a rate of 300 mL/min under stirring, and heated to react in a 40° C. water bath, with the system pH value controlled at 10.

(4) After the reaction in step (3) was completed, the stirring and heating were stopped, and the system was stood for 24 hours and then filtered to obtain a gelatinous precipitate. The gelatinous precipitate was collected and washed until the pH value reached 7 to obtain a composite material for impregnating the cathode.

(5) The composite material obtained in step (4) was coated onto the surface of a cathode substrate, which was specifically a porous tungsten substrate, and dried at 200° C. under vacuum to obtain a dried cathode.

(6) The dried cathode from step (5) was placed into a hydrogen furnace, heated to 1100° C. at a rate of 50° C./min and then hold at 1100° C. for 5 minutes, and subsequently heated to 1650° C. at a rate of 20° C./min and then hold at 1650° C. for 3 minutes. After that, the heated cathode was cooled to room temperature, and the hydrogen furnace was opened to obtain a resulting thermionic cathode.

The thermionic cathodes prepared according to the above examples were subjected to electron emission performance testing.

The cathodes manufactured by the methods of the present application exhibit high emission current density and uniform emission quality, meeting the practical application requirements of thermionic devices, showing significant application value and promising application prospects.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be defined by the appended claims.

What is claimed is:

1. A method for manufacturing a cathode, comprising:
mixing and reacting cations containing a cathode element with a precipitant in a solution to obtain a gelatinous precipitate; and
coating the gelatinous precipitate on a surface of a cathode substrate.

2. The method according to claim 1, further comprising:
drying the cathode substrate coated with the gelatinous precipitate to obtain a dried cathode substrate; and
subjecting the dried cathode substrate to melting impregnation.

3. The method according to claim 1, wherein mixing and reacting the cations containing the cathode element with the precipitant in the solution to obtain the gelatinous precipitate comprises:
in a pH value ranging from 8 to 10, mixing and reacting the cations containing the cathode element with the precipitant in the solution to obtain the gelatinous precipitate.

4. The method according to claim 1, wherein mixing and reacting the cations containing the cathode element with the precipitant in the solution to obtain the gelatinous precipitate comprises:
adding a solution containing the cations dropwise into a solution containing the precipitant at a rate of 100 mL/min to 600 mL/min.

5. The method according to claim 4, wherein in the solution containing the precipitant, a concentration of the precipitant is in a range from 1 mol/L to 3 mol/L.

6. The method according to claim 1, wherein the gelatinous precipitate comprises a hydroxide of the cathode element, an oxyhydroxide of the cathode element, or a combination thereof.

7. The method according to claim 1, wherein the gelatinous precipitate comprises Al(OH)₃, AlOOH, or a combination thereof.

8. The method according to claim 1, wherein during mixing and reacting the cations containing the cathode element with the precipitant in the solution, a reaction temperature is in a range from 20° C. to 80° C., and/or a reaction time lasts for 0.5 hours to 2 hours.

9. The method according to claim 1, wherein the precipitant comprises a carbonate, and/or the solution contains nitrate ions.

10. The method according to claim 1, wherein the precipitant comprises ammonium carbonate, ammonium bicarbonate, or a combination thereof.

11. The method according to claim 1, wherein a molar ratio of the cations to the precipitant is in a range from 1:2 to 1:5.

12. The method according to claim 1, wherein the cathode element comprises aluminum, scandium, yttrium, or any combination thereof.

13. The method according to claim 12, wherein the cathode element further comprises at least one of barium or calcium.

14. The method according to claim 1, wherein a material of the cathode substrate comprises at least one of porous molybdenum, porous tungsten, or a combination thereof.

15. The method according to claim 2, wherein the cathode substrate coated with the gelatinous precipitate is dried at a temperature of 100° C. to 300° C. under vacuum for 2 hours to 5 hours.

16. The method according to claim 2, wherein the melt impregnation comprises:
in a hydrogen atmosphere, heating to a temperature of 1000° C. to 1200° C. at a rate of 30° C./min to 60° C./min and then holding the temperature for 3 minutes to 8 minutes, and further heating to a temperature of 1550° C. to 1750° C. at a rate of 10° C./min to 30° C./min and then holding the temperature for 1 minute to 5 minutes.

17. The method according to claim 1, wherein during the method, no binder is coated on the cathode substrate.

18. A cathode applied in a microwave device, the cathode being manufactured by the method according to claim 1.
